(19) United States
(12) Patent Application Publication
(10) Pub. No.: US 2026/0042487 A1
(43) Pub. Date: Feb. 12, 2026

(54) VEHICLE FLUID MANAGEMENT ASSEMBLY

(71) Applicant: FORD GLOBAL TECHNOLOGIES, LLC, Dearborn, MI (US)

(72) Inventors: Genaro Garduno, Mexico City (MX); Arturo Martinez, Toluca (MX); Danielle Kozak, Dearborn, MI (US); James J. Ellison, Ferndale, MI (US); Mehran Shahabi, Ypsilanti, MI (US); Cullen Worthem, JR., Troy, MI (US); Francisco Damian Sanchez Patiño, Metepec (MX)

(21) Appl. No.: 18/797,235

(22) Filed: Aug. 7, 2024

(51) Int. Cl. B62D 25/08

(52) U.S. Cl. CPC B62D 25/081; B62D 25/082

(57) ABSTRACT

A device may include a cowl having a first region that supports a battery within a compartment of a vehicle. A device may include a fluid management tray beneath the cowl, the fluid management tray including a fluid collection cavity and a fluid directing channel, the fluid collection cavity configured to receive fluid from the cowl, the fluid directing channel configured to direct fluid from the fluid collection cavity toward an outboard side of the compartment.

### TECHNICAL FIELD

This disclosure relates generally to managing fluid within a compartment of a vehicle.

### BACKGROUND

Vehicle windshields can direct fluid (e.g., rain) downward toward a base of the windshield. Weatherstripping and seals around the perimeter of the windshield can block fluid from entering a passenger compartment. Some fluid may travel toward a compartment of the vehicle, such as an engine compartment or frunk.

### SUMMARY

In some aspects, the techniques described herein relate to a vehicle fluid management assembly, including: a cowl having a first region that supports a battery within a compartment of a vehicle; and a fluid management tray beneath the cowl, the fluid management tray including a fluid collection cavity and a fluid directing channel, the fluid collection cavity configured to receive fluid from the cowl, the fluid directing channel configured to direct fluid from the fluid collection cavity toward an outboard side of the compartment.

In some aspects, the techniques described herein relate to a vehicle fluid management assembly, wherein the cowl includes a second region that receives fluid from a fluid source, the second region including a drainage channel, a plurality of drainage openings, and a reservoir, the drainage channel configured to direct fluid from the fluid source in a first direction to the plurality of drainage openings and in a second direction to the reservoir.

In some aspects, the techniques described herein relate to a vehicle fluid management assembly, wherein the drainage channel has a V-shaped profile.

In some aspects, the techniques described herein relate to a vehicle fluid management assembly, wherein the plurality of drainage openings are configured to direct fluid from the drainage channel to the fluid collection cavity of the fluid management tray, and the reservoir is configured to direct fluid from the drainage channel away from the outboard side of the compartment through an outlet.

In some aspects, the techniques described herein relate to a vehicle fluid management assembly, wherein the outlet faces away from components in the compartment.

In some aspects, the techniques described herein relate to a vehicle fluid management assembly, further including an insulation member that at least partially separates the first region from the second region.

In some aspects, the techniques described herein relate to a vehicle fluid management assembly, wherein the fluid collection cavity includes a first section that is in fluid communication with the fluid directing channel and a second section that is in fluid communication with the first section, the first section having a partition wall configured to control a flow of fluid within the first section.

In some aspects, the techniques described herein relate to a vehicle fluid management assembly, further including an HVAC system of the vehicle that is in fluid communication with the second section, wherein the first section receives fluid from the cowl, and the second section receives fluid from the HVAC system.

In some aspects, the techniques described herein relate to a vehicle fluid management assembly, wherein the partition wall is configured to direct fluid from the first section along a first flow path to the fluid directing channel and to direct fluid from the second section along a second flow path to the fluid directing channel.

In some aspects, the techniques described herein relate to a vehicle fluid management assembly, further including a plurality of baffles along the second flow path, the plurality of baffles configured to interrupt the flow of fluid from the second section along the second flow path.

In some aspects, the techniques described herein relate to a vehicle fluid management assembly, wherein the fluid directing channel is beneath the first region of the cowl that supports the battery.

In some aspects, the techniques described herein relate to a vehicle fluid management assembly, wherein the fluid directing channel extends beneath the first region of the cowl that supports the battery.

In some aspects, the techniques described herein relate to a vehicle fluid management assembly, wherein the compartment is an engine compartment.

In some aspects, the techniques described herein relate to a vehicle fluid management method, including: receiving a flow of fluid in a fluid collection cavity of a fluid management tray, the fluid management tray beneath a cowl having a first portion that supports a battery within a compartment of a vehicle; and directing the fluid received within the fluid collection cavity along a fluid directing channel of the fluid management tray toward an outboard side of the compartment.

In some aspects, the techniques described herein relate to a method, wherein the fluid is directed through the fluid directing channel away from components in the compartment.

In some aspects, the techniques described herein relate to a method, wherein the cowl includes a second region having a drainage channel, a plurality of drainage openings, and a reservoir, and further including directing fluid from the drainage channel in a first direction toward the fluid collection cavity through at least one of the plurality of drainage openings and in a second direction toward a different outboard side of the compartment through an outlet of the reservoir.

In some aspects, the techniques described herein relate to a method, wherein the fluid collection cavity includes a first section that is in fluid communication with the fluid directing channel and a second section that is in fluid communication with the first section, the first section having a partition wall that provides a first flow path and a second flow path.

In some aspects, the techniques described herein relate to a method, further including directing fluid from the first section along the first flow path and directing fluid from the second section along the second flow path.

In some aspects, the techniques described herein relate to a method, further including interrupting a flow of fluid along the second flow path.

In some aspects, the techniques described herein relate to a method, wherein the compartment is an engine compartment.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a top view of a portion of a vehicle with a hood removed to show a fluid management assembly of the vehicle according to an exemplary aspect of the present disclosure within an engine compartment of the vehicle.

FIG. 2 illustrates a perspective view of the fluid management assembly of FIG. 1.

FIG. 3 illustrates a top view of the fluid management assembly of FIG. 2, which includes a cowl and a fluid management tray.

FIG. 4 is a top view of the fluid management tray of the fluid management assembly.

### DETAILED DESCRIPTION

This disclosure relates generally to a vehicle fluid management assembly for managing fluid near a base of a windshield. The fluid management assembly can be used to guide fluid away from fluid-sensitive components. In an example, the fluid management assembly includes a cowl having a first region that supports a battery within a compartment of the vehicle and a fluid management tray beneath the cowl. These and other features are discussed in greater detail in the following paragraphs of this detailed description.

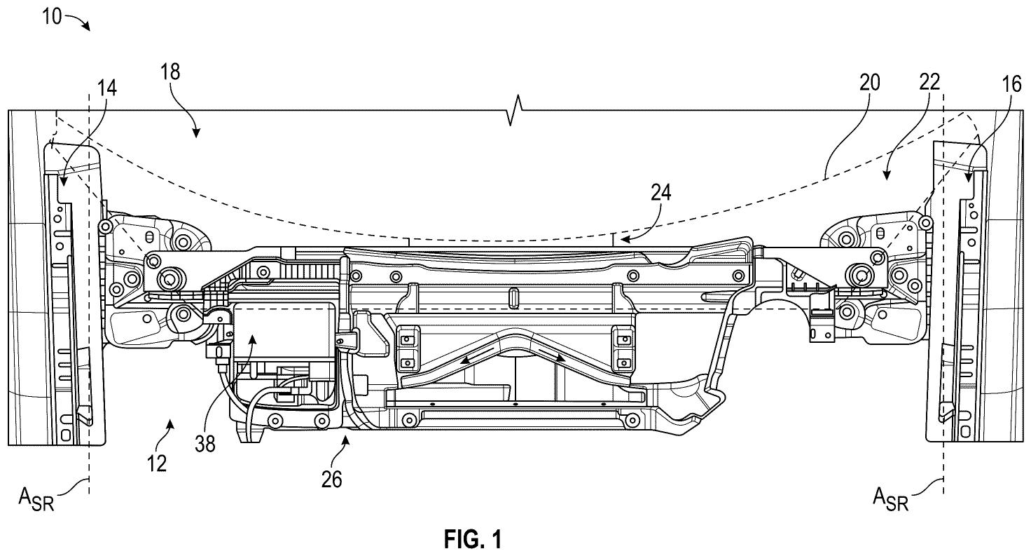

FIG. 1 schematically illustrates select portions of a vehicle 10. Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component or system.

The vehicle 10 includes a compartment, here an engine compartment 12, that is at least partially defined between a pair of opposing and longitudinally extending first and second siderails 14, 16. The engine compartment 12 is beneath a windshield 18 of the vehicle 10. While the examples of this disclosure are described in connection with the engine compartment 12, the examples could be used in connection with other compartments, such as a frunk of an electric vehicle.

The engine compartment 12 establishes a space for housing components of the vehicle 10, such as an engine. The engine compartment 12 in this example, additionally houses components of an electrical system, such as a battery, wiring harnesses, and various sensors for example.

The first siderail 14 and the second siderail 16 each extend along a respective siderail axis A_{SR} and establish sides of the engine compartment 12. The first siderail 14 and the second siderail 16 are part of the body or frame of the vehicle 10.

As the vehicle 10 is operated, fluid can contact the windshield 18. Some of the fluid deposited on the windshield 18 may flow downward toward a base 20 of the windshield 18 where the windshield 18 interfaces with a cowl cover 22 (shown in dashed lines for illustrative purposes) of the vehicle 10.

The cowl cover 22, in this example, is a dual functional cowl cover that acts as an air intake for an HVAC (Heating, Ventilation, and Air Conditioning) system 24 of the vehicle 10 and manages fluid from the windshield 18.

In an example, air from outside the vehicle 10 can enter through vents in the cowl cover 22, which directs the air into the HVAC system 24 where the air can be heated, cooled, or otherwise circulated inside the vehicle 10.

Fluid from the windshield 18 can sometimes ingress into the HVAC system 24 through the cowl cover 22. In this example, the cowl cover 22 is configured to collect this fluid and direct the fluid toward specific discharge points on the vehicle 10. As used herein, the “fluid” can include any fluid such as water, rain, windshield washer fluid, etc.

A fluid management assembly 26 is supported within the engine compartment 12 adjacent to the HVAC system 24. The fluid management assembly 26 can at least partially fill a gap between a vehicle hood (not shown) and the windshield 18. In this example, the fluid management assembly 26 extends laterally between the siderail axes A_{SR}.

The fluid management assembly 26 is configured to collect and guide fluid from a fluid source (e.g., from the windshield 18 and/or the cowl cover 22) away from components in the compartment 12. In this example, the fluid management assembly 26 blocks fluid from entering the HVAC system 24. Although the fluid management assembly 26 is described herein with respect to the HVAC system 24, the fluid management assembly 26 could be adapted to block fluid from entering other components housed within the compartment 12, including but not limited to components of an electrical system such as a battery, wiring harnesses, and various sensors for example.

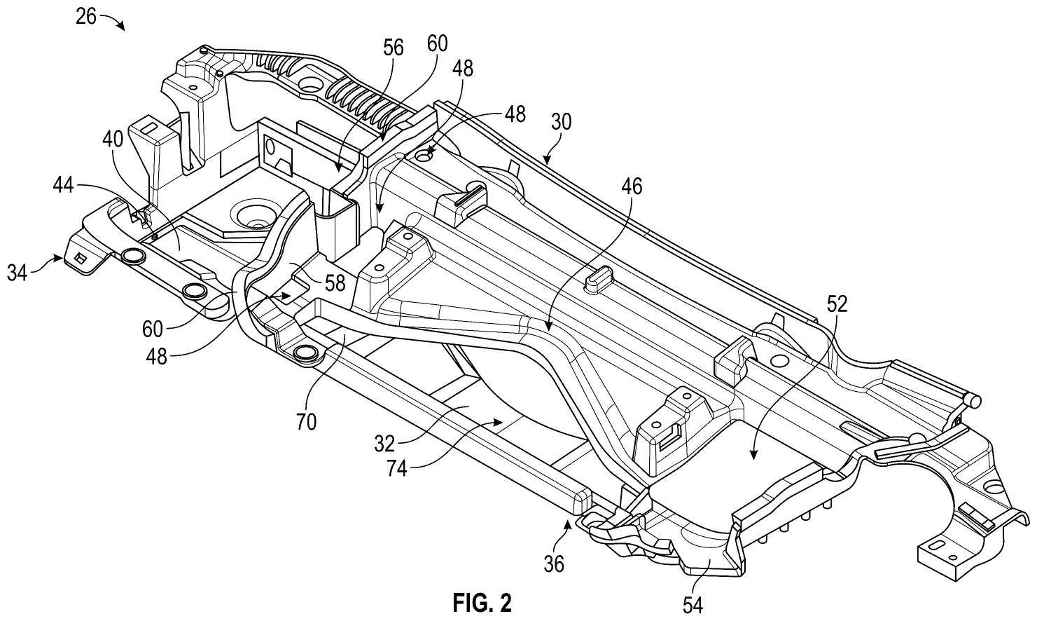

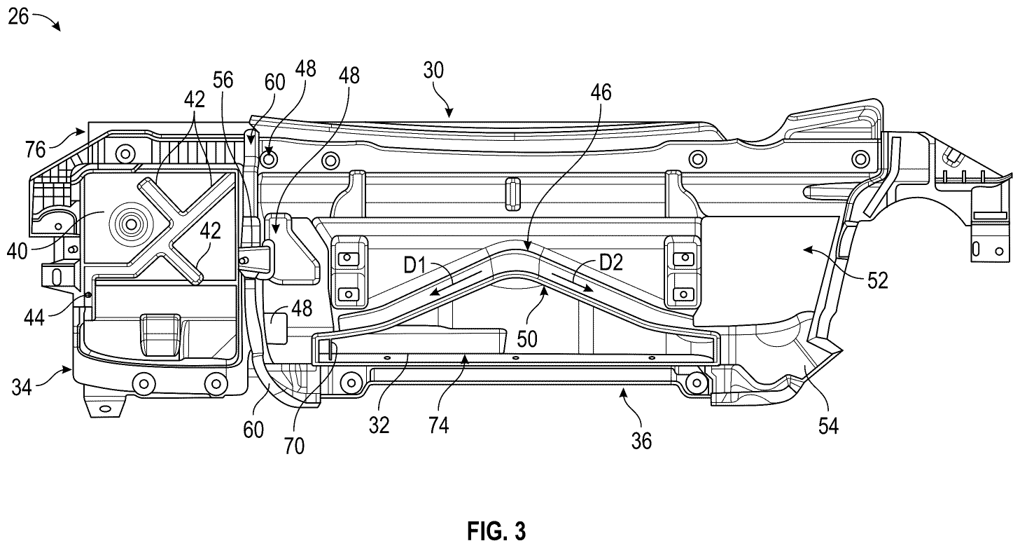

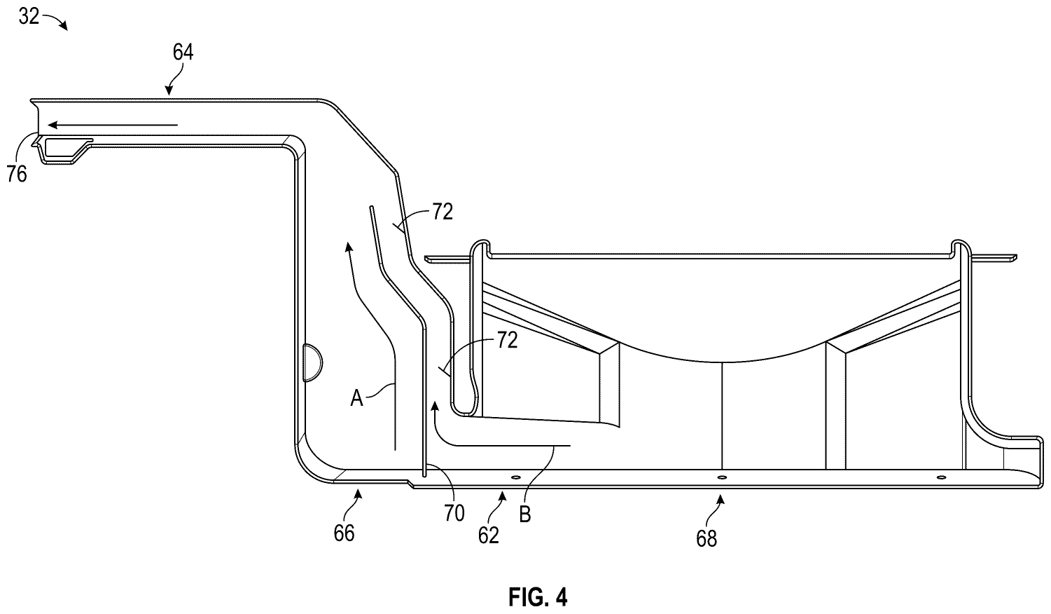

Referring now to FIGS. 2-4, the fluid management assembly 26 includes a cowl 30 and a fluid management tray 32 disposed beneath the cowl 30. That is, the cowl 30 is vertically above the fluid management tray 32.

The cowl 30 includes a first region 34 and a second region 36. The first region 34 is configured to support a battery 38 (see FIG. 1) within the compartment 12. In this example, the first region 34 is a lower housing that is dimensioned to support the battery 38. A floor 40 in the first region 34 contacts a lower surface of the battery 38 when the battery 38 is supported in the first region 34. The floor 40 includes a plurality of channels 42 for collecting and guiding substances (e.g., battery acid, liquid electrolyte, etc.) that are released from the battery 38 outboard to a port 44.

The second region 36 receives fluid from a fluid source (e.g., from the windshield 18 and/or cowl cover 22). The second region 36 includes a drainage channel 46 and a plurality of drainage openings 48. The example drainage channel 46 has a V-shaped profile that is at least partially defined by a guide wall 50. In this example, the guide wall 50 directs fluid from the fluid source in a first direction D1 toward at least one of the plurality of drainage openings 48 and in a second direction D2 toward a reservoir 52. The plurality of drainage openings 48 direct fluid from the drainage channel 46 to the fluid management tray 32. The reservoir 52 is configured to collect fluid from the drainage channel 46 and direct the fluid toward an outboard side of the compartment 12 (i.e., toward the second siderail 16) through an outlet 54. In some situations, such as heavy rains, the amount of fluid received from the fluid source may exceed the drainage capacity of the fluid management assembly 26. In these situations, excess fluid is drained to ground through the outlet 54. The outlet 54 in this example faces away from components in the compartment 12.

In the illustrated embodiment, the first and second regions 34, 36 are separated by a barrier 58. The barrier 58 blocks fluid transfer between the first and second regions 34, 36. An insulation member 60 is disposed on the barrier 58 and at least partially separates the first and second regions 34, 36. The insulation member 60 can be a discontinuous layer including separate sections of insulation material that are not in direct contact with one another. In this example, sections of the insulation member 60 are separated by a gap 56. In other examples, the insulation member 60 could be a continuous layer such that there is no gap. The insulation member 60 is configured to reduce heat transfer between the first and second regions 34, 36. The insulation member 60 can be made of a material having high thermal resistance capabilities.

The fluid management tray 32 is secured (e.g., welded, fastened, adhered, etc.) beneath the cowl 30. The fluid management tray 32 includes a fluid collection cavity 62 that is disposed beneath the second region 36 of the cowl 30 and a fluid directing channel 64 that is disposed beneath the first region 34 of the cowl 30. The fluid collection cavity 62 is divided into a first section 66 that is in fluid communication with the fluid directing channel 64 and a second section 68 that is in fluid communication with the first section 66. The first section 66 is disposed beneath at least one of the plurality drainage openings 48 of the cowl 30 and the second section 68 is disposed beneath the drainage channel 46 of the cowl 30.

The first section 66 includes a partition wall 70 that controls a flow of fluid within the first section 66. In this example, the partition wall 70 is upstream of the plurality of drainage openings 48 and provides a first flow path A and a second flow path B in the first section 66. A plurality of baffles 72 are provided along the second flow path B. The plurality of baffles 72 are oriented to redirect or otherwise interrupt a flow of fluid from the second section 68 along the second flow path B. The second section 68 is in fluid communication with the HVAC system 24 of the vehicle 10 (see FIG. 1).

Fluid from the plurality of drainage openings 48 is received in the first section 66 and directed along the first flow path A by the partition wall 70. Operation of the HVAC system 24 can form condensed fluid droplets in the second section 68. Any fluid that flows over the guide wall 50 of the cowl 30 is received in the second section 68 through an opening 74 established in the cowl 30. The fluid in the second section 68 is then directed along the second flow path B by the partition wall 70.

The fluid directing channel 64 receives fluid from the first and second sections 66, 68 of the fluid collection cavity 62. The fluid directing channel 64 is disposed beneath the first region 34 of the cowl 30. That is, the fluid directing channel 64 is beneath the battery 38 of the vehicle 10 (see FIG. 1). In this example, the fluid directing channel 64 extends laterally outward from the first section 66. The fluid directing channel 64 directs fluid from the fluid collection cavity 62 toward an outboard side of the compartment 12 (i.e., toward the first siderail 14) through an outlet 76 which faces away from components in the compartment 12. The fluid directing channel 64 thus serves as a controlled pathway for directing fluid under the battery 38.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle fluid management assembly, comprising:
a cowl having a first region that supports a battery within a compartment of a vehicle; and
a fluid management tray beneath the cowl, the fluid management tray including a fluid collection cavity and a fluid directing channel, the fluid collection cavity configured to receive fluid from the cowl, the fluid directing channel configured to direct fluid from the fluid collection cavity toward an outboard side of the compartment.

2. The vehicle fluid management assembly of claim 1, wherein the cowl includes a second region that receives fluid from a fluid source, the second region including a drainage channel, a plurality of drainage openings, and a reservoir, the drainage channel configured to direct fluid from the fluid source in a first direction to the plurality of drainage openings and in a second direction to the reservoir.

3. The vehicle fluid management assembly of claim 2, wherein the drainage channel has a V-shaped profile.

4. The vehicle fluid management assembly of claim 2, wherein the plurality of drainage openings are configured to direct fluid from the drainage channel to the fluid collection cavity of the fluid management tray, and the reservoir is configured to direct fluid from the drainage channel away from the outboard side of the compartment through an outlet.

5. The vehicle fluid management assembly of claim 4, wherein the outlet faces away from components in the compartment.

6. The vehicle fluid management assembly of claim 2, further comprising an insulation member that at least partially separates the first region from the second region.

7. The vehicle fluid management assembly of claim 1, wherein the fluid collection cavity includes a first section that is in fluid communication with the fluid directing channel and a second section that is in fluid communication with the first section, the first section having a partition wall configured to control a flow of fluid within the first section.

8. The vehicle fluid management assembly of claim 7, further comprising an HVAC system of the vehicle that is in fluid communication with the second section, wherein the first section receives fluid from the cowl, and the second section receives fluid from the HVAC system.

9. The vehicle fluid management assembly of claim 7, wherein the partition wall is configured to direct fluid from the first section along a first flow path to the fluid directing channel and to direct fluid from the second section along a second flow path to the fluid directing channel.

10. The vehicle fluid management assembly of claim 9, further comprising a plurality of baffles along the second flow path, the plurality of baffles configured to interrupt the flow of fluid from the second section along the second flow path.

11. The vehicle fluid management assembly of claim 1, wherein the fluid directing channel is beneath the first region of the cowl that supports the battery.

12. The vehicle fluid management assembly of claim 1, wherein the fluid directing channel extends beneath the first region of the cowl that supports the battery.

13. The vehicle fluid management assembly of claim 1, wherein the compartment is an engine compartment.

14. A vehicle fluid management method, comprising:
receiving a flow of fluid in a fluid collection cavity of a fluid management tray, the fluid management tray beneath a cowl having a first portion that supports a battery within a compartment of a vehicle; and
directing the fluid received within the fluid collection cavity along a fluid directing channel of the fluid management tray toward an outboard side of the compartment.

15. The method of claim 14, wherein the fluid is directed through the fluid directing channel away from components in the compartment.

16. The method of claim 14, wherein the cowl includes a second region having a drainage channel, a plurality of drainage openings, and a reservoir, and further comprising directing fluid from the drainage channel in a first direction toward the fluid collection cavity through at least one of the plurality of drainage openings and in a second direction toward a different outboard side of the compartment through an outlet of the reservoir.

17. The method of claim 16, wherein the fluid collection cavity includes a first section that is in fluid communication with the fluid directing channel and a second section that is in fluid communication with the first section, the first section having a partition wall that provides a first flow path and a second flow path.

18. The method of claim 17, further comprising directing fluid from the first section along the first flow path and directing fluid from the second section along the second flow path.

19. The method of claim 18, further comprising interrupting a flow of fluid along the second flow path.

20. The method of claim 14, wherein the compartment is an engine compartment.
